(19) United States
(12) Patent Application Publication
(10) Pub. No.: US 2024/0295738 A1
(43) Pub. Date: Sep. 5, 2024

(54) METHOD AND SYSTEM FOR AN OPTICAL ENGINE

(71) Applicant: TEXAS INSTRUMENTS INCORPORATED, Dallas, TX (US)

(72) Inventor: Zhongyan Sheng, Allen, TX (US)

(21) Appl. No.: 18/587,051

(22) Filed: Feb. 26, 2024

Related U.S. Application Data
(60) Provisional application No. 63/487,645, filed on Mar. 1, 2023.

(51) Int. Cl. G02B 27/01; G02B 13/00

(52) U.S. Cl. CPC G02B 27/0172; G02B 13/0095; G02B 2027/0178

(57) ABSTRACT

A system includes an illumination module configured to produce illumination light and a prism. The system also includes relay optics optically coupled between the illumination module and the prism, the relay optics having a first surface, a second surface, and a third surface. The first surface is configured to reflect the illumination light to produce first reflected light, the second surface is configured to reflect the first reflected light to produce second reflected light, the third surface is configured to reflect the second reflected light to produce third reflected light, and the second surface is configured to transmit the third reflected light to produce transmitted light towards the prism. Additionally, the system includes a spatial light modulator (SLM) optically coupled to the prism. The prism is configured to direct the transmitted light towards the SLM, and the SLM is configured to produce modulated light based on the transmitted light.

### CROSS-REFERENCE TO RELATED APPLICATION

This application claims priority to U.S. Provisional Patent Application No. 63/487,645, filed on Mar. 1, 2023, and entitled “High Efficiency Near Eye Display Engine with Compact Illumination,” which application is hereby incorporated herein by reference in its entirety.

### TECHNICAL FIELD

The present application relates in general to optical systems, and, in particular, to a method and system for an optical engine.

### BACKGROUND

Projection displays are used in many applications, for example near-eye displays such as augmented reality (AR) and virtual reality (VR). Near-eye displays may illuminate a spatial light modulator (SLM) by an illumination source. In near-eye displays, it is desirable to have a compact size for the entire system while maintaining low power.

### SUMMARY

An example system includes an illumination module configured to produce illumination light and a prism. The system also includes relay optics optically coupled between the illumination module and the prism, the relay optics having a first surface, a second surface, and a third surface. The first surface is configured to reflect the illumination light to produce first reflected light, the second surface is configured to reflect the first reflected light to produce second reflected light, the third surface is configured to reflect the second reflected light to produce third reflected light, and the second surface is configured to transmit the third reflected light to produce transmitted light towards the prism. Additionally, the system includes a spatial light modulator (SLM) optically coupled to the prism. The prism is configured to direct the transmitted light towards the SLM, and the SLM is configured to produce modulated light based on the transmitted light.

An example system includes an illumination module and a prism. The system also includes a single-piece relay optics optically coupled between the illumination module and the prism and a spatial light modulator (SLM) optically coupled to the prism.

An example system includes an array of light emitting diodes (LEDs) including a first LED configured to produce first light and a second LED configured to produce second light. The system also includes relay optics and at least one lens optically coupled between the array of LEDs and the relay optics, the at least one lens configured to direct the first light and the second light towards the relay optics. Additionally, the system includes a spatial light modulator (SLM) and a prism optically coupled between the relay optics and the spatial light modulator. The relay optics is configured to direct the first light and the second light towards the prism. The prism is configured to direct the first light towards a first zone of the SLM and to direct the second light towards a second zone of the SLM.

### BRIEF DESCRIPTION OF THE DRAWINGS

For a more complete understanding of the illustrative examples of aspects of the present application that are described herein and the advantages thereof, reference is now made to the following descriptions taken in conjunction with the accompanying drawings, in which:

FIG. 1A illustrates an example near-eye display system.

FIG. 1B illustrates an example optical engine.

FIGS. 2A-2D illustrate a portion of an example optical engine.

FIGS. 3A and 3B illustrate a portion of another example optical engine.

FIGS. 4A and 4B illustrate a portion of another example optical engine.

FIG. 5A illustrates a portion of an additional example optical engine.

FIGS. 5B and 5C illustrate an example illumination module.

Corresponding numerals and symbols in the different figures generally refer to corresponding parts unless otherwise indicated. The figures are drawn to clearly illustrate the relevant aspects of the illustrative example arrangements and are not necessarily drawn to scale.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

In this description, elements that are optically coupled have an optical connection between the elements, but various intervening optical components can exist between elements that are optically coupled.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified in the below description.

### DETAILED DESCRIPTION

Although the example illustrative arrangements have been described in detail, it should be understood that various changes, substitutions and alterations can be made herein without departing from the spirit and scope of the present application as defined by the appended claims.

Projection displays may have an optical engine including an illumination light source optically coupled to illumination optics, a prism, and spatial light modulator (SLM). For near-eye displays such as augmented reality (AR) and virtual reality (VR), it is desirable to have an optical engine is very compact while being low in power consumption and high in efficiency. A near-eye display may be a wearable device. In an example, the illumination optics is relay optics, for example a single-piece relay optics. In an example, the relay optics at least partially occupies space remaining in a cube containing the prism, to make efficient use of space. In an example, relay optics is compact, light in weight, and low in cost.

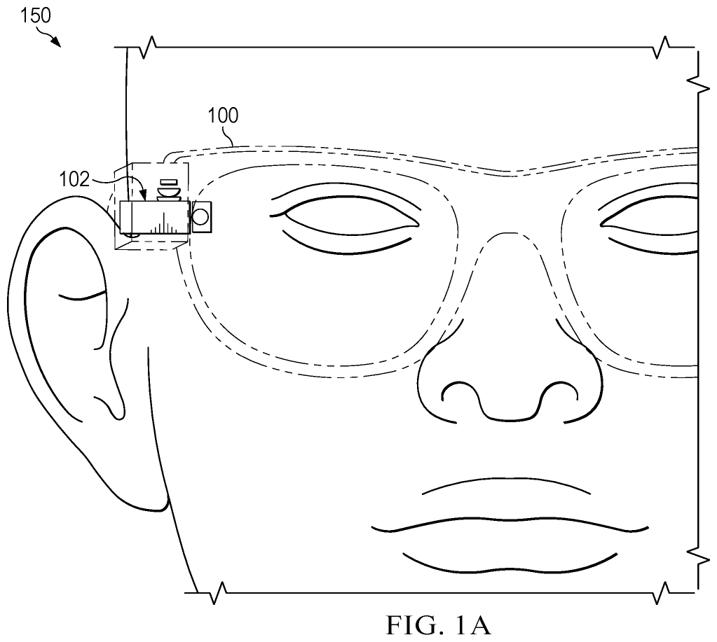

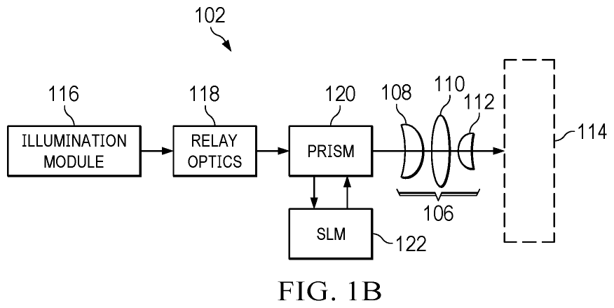

FIG. 1A illustrates a near-eye display 150 and FIG. 1B illustrates an optical engine 102. The near-eye display 150 has the optical engine 102 near the temples of frames 100. In an example, the optical engine 102 is compact, low in power consumption, and light in weight. While one optical engine is pictured in FIG. 1A, the near-eye display 150 may contain two optical engines, one on each temple for each eye.

FIG. 1B illustrates a functional block diagram of the optical engine 102. The optical engine 102 includes an illumination module 116, relay optics 118, prism 120, spatial light module (SLM) 122, projection optics 106, and waveguide 114. The illumination module 116 is a compact illumination module configured to produce illumination light having a small pupil size. The illumination module 116 may be a one channel illumination module, a two channel illumination module, or a three channel illumination module. In one example, the illumination module 116 has one or more light emitting diode (LED) coupled to at least lens and a lens array. The illumination module may also contain a dichroic mirror and/or a dichroic wedge to combine light from multiple LEDs. In another example, the illumination module contains an array of light sources, for example LEDs, coupled to at least one lens, where each light source illuminates a zone of the SLM 122.

The illumination module 116 is optically coupled to relay optics 118, and relay optics 118 is optically coupled to a prism 120. In an example, the relay optics 118 is a single piece relay optics. In another example, the relay optics 118 contains multiple components with or without air spaces. In an example, the relay optics 118 is composed of plastic or glass. The use of plastic for the relay optics 118 may reduce the cost and weight of the relay optics 118. The relay optics 118 may be at least partially arranged in space adjacent the prism 120, reducing the size of the optical engine 102. The relay optics 118 may have a first surface, a second surface, a third surface, and a fourth surface. The illumination light enters the relay optics 118 via the first surface. The second surface reflects the illumination light to produce first reflected light. The third surface reflects the reflected light using total internal reflect to produce second reflected light. The fourth surface reflects the second reflected light to produce third reflected light. The third surface then transmits the reflected light towards the prism 120 as transmitted light.

The prism 120 is optically coupled to the relay optics 118, to a spatial light modulator (SLM) 122, and to projection optics 106. The prism 120 directs the transmitted light from the relay optics 118 towards the SLM 122. The SLM may be a liquid crystal on silicon (LCoS) device, a liquid crystal display (LCD), a digital micromirror device (DMD), or another SLM device. The SLM 122 modulates the transmitted light to produce modulated light. The SLM 122 sets pixels to on or off values to produce an image based on incident light. The prism 120 directs the modulated light towards projection optics 106.

The projection optics 106 is optically coupled to a waveguide 114. In FIG. 1B, the projection optics 106 is illustrated having three lenses, lens 108, lens 110, and 112. However, in other examples, the projection optics 106 may have fewer or more lenses. For example, the projection optics 106 may contain a single freeform eyepiece. The projection optics 106 directs the modulated light towards the waveguide 114 as projection light. The waveguide 114 directs the modulated light towards a user's eye (not pictured in FIG. 1B).

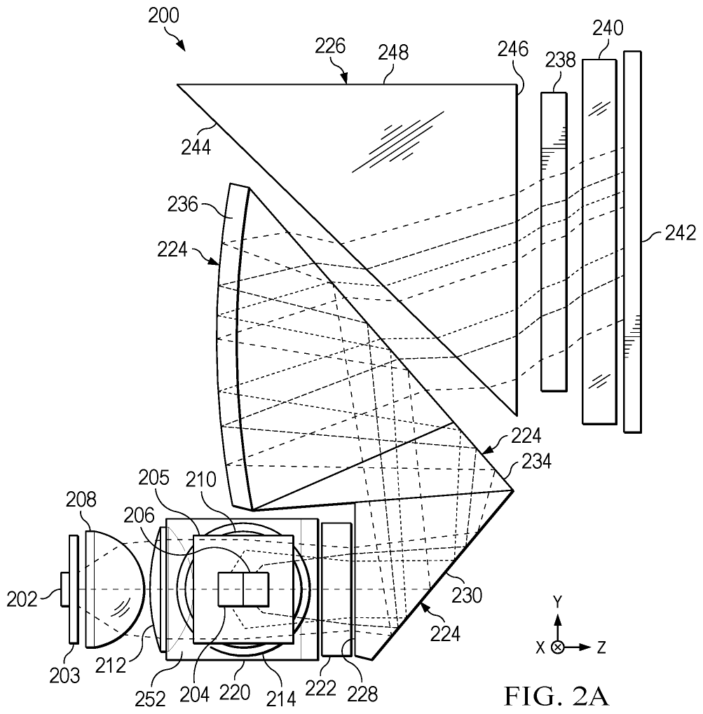

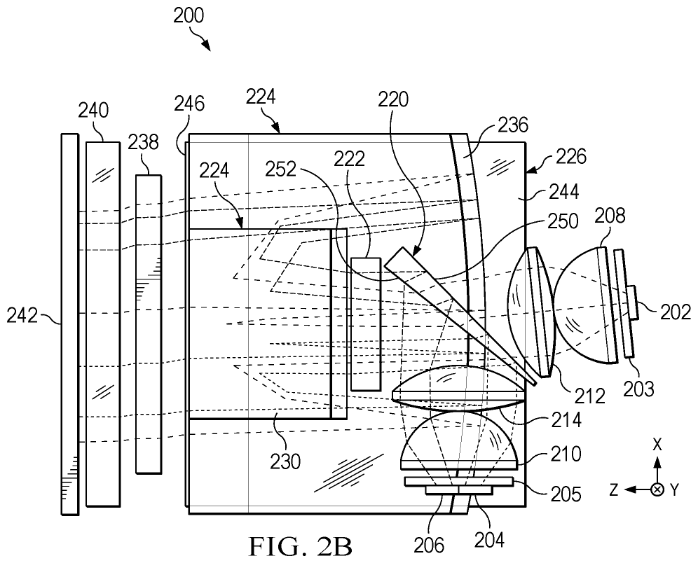

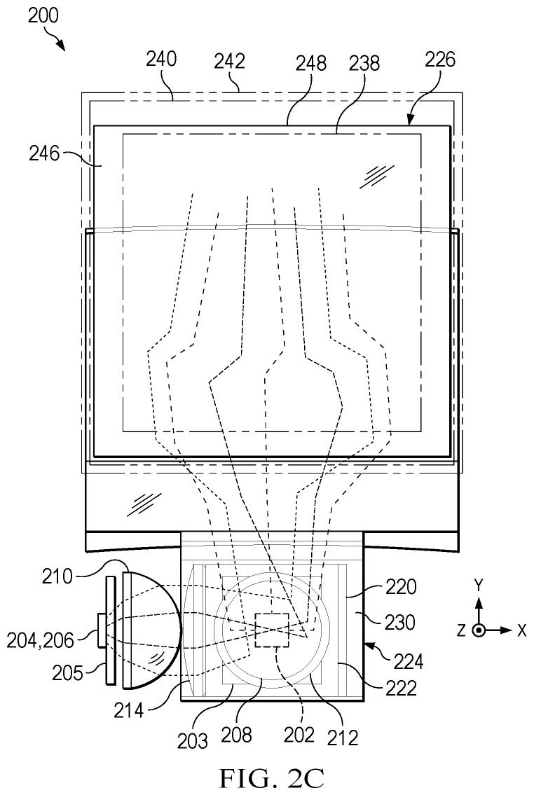

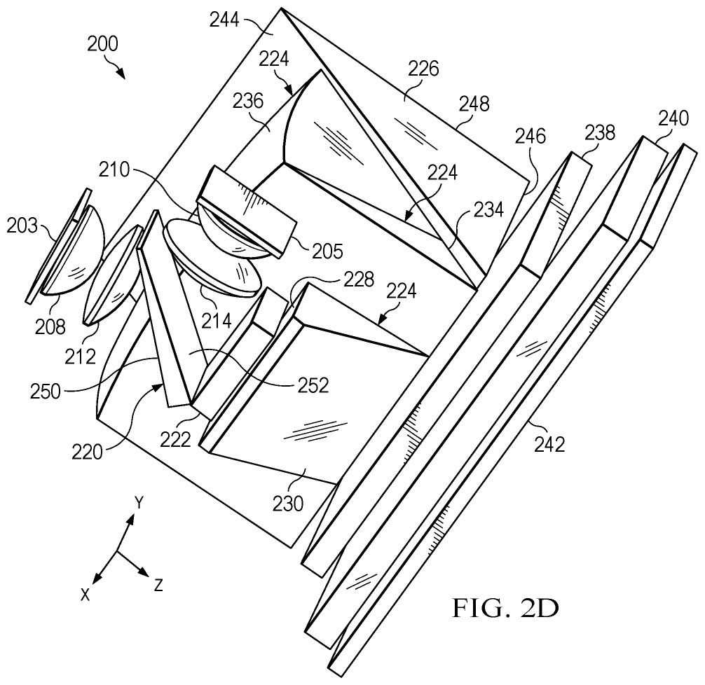

FIGS. 2A-2D illustrate different views of an optical engine 200. FIG. 2A illustrates a view of the optical engine 200 along a first axis, FIG. 2B illustrates a view of the optical engine 200 along a second axis, FIG. 2C illustrates a view of the optical engine 200 along a third axis, and FIG. 2D illustrates a three-dimensional view of the optical engine 200. In an example, the first axis is the Y-Z axis, the second axis is the X-Z axis, and the third axis is the X-Y axis. In other examples, different axes are used. The optical engine 200 includes an illumination module, relay optics 224, a prism 226, and an SLM 242.

The optical engine 200 may be an example of at least a portion of the optical engine 102 illustrated in FIGS. 1A and 1B. LED 202, cover glass 203, collimating lens 208, lens 212, LED 204, LED 206, cover glass 205, collimating lens 210, lens 214, dichroic wedge 220, and lens array 222 form an illumination module, for example the illumination module 116 illustrated in FIG. 1B. These components form a 2-channel illumination source, but other examples may include a 1-channel illumination source or a 3-channel illumination source. LED 202, LED 204, and LED 206 are relatively small LEDs to maintain a small illumination pupil size and a low etendue. In an example, the LED 202 is physically and optically coupled to cover glass 203, and the LED 204 and the LED 206 are physically and optically coupled to a cover glass 205. In some examples, the cover glass 203 and the cover glass 205 are not present. In an example, the LED 202 produces first initial light having a first color, the LED 204 produces second initial light having a second color, and the LED 206 produces third initial light having a third color. In an example, the first color is green, the second color is red, and the third color is blue. In another example, the first color is green, the second color is blue, and the third color is red. In an additional example, the first color is red or blue, the second color is green, and the third color is blue or red. In an example, the first light, the second light, and the third light are time multiplexed. The LED 202 is optically coupled to collimating lens 208 and to lens 212, which direct the first initial light towards the dichroic wedge 220. The LED 204 and the LED 206, which are located adjacent to each other, are both optically coupled to collimating lens 210 and to lens 214, which direct the second light and the third light towards the dichroic wedge 220. The dichroic wedge 220 combines the first light having the first color, the second light having the second color, and the third light having a third color. The dichroic wedge 220 has surface 250 and surface 252 that reflect or transmit light based on the color of the light. Surface 250 and surface 252 of the dichroic wedge transmit the first light having the first color, directing the first light towards the lens array 222. The surface 252 reflects the third light having the third color, directing it towards the lens array 222. The surface 252 transmits the second light having the second color. The second light proceeds to the surface 250, which reflects the second light having the second color. The second light is then transmitted through the surface 252, towards the lens array 222. The angle of the two surfaces of the dichroic wedge 220 are such that the second light, the third light, and the first light are centered after the dichroic wedge 220. The lens array 222 homogenizes the first light, the second light, and the third light, to produce illumination light. The lens array 222, for example a fly's eye array, forms multiple images of the initial light on the SLM 242, where each image covers all of the SLM 242, to provide uniformity from averaging. In an example, the lens array 222 is a four by four lens array, but in other examples different sized lens arrays may be used.

Relay optics 224 is optically coupled to the illumination module, and to the prism 226. There may be a small air gap between the lens array 222 and the surface 228 of the relay optics 224. In an example, the prism 226 takes up about half of a cubic area, and the relay optics 224 takes up at least a portion of the cubic area not taken up by the prism 226, making efficient use of space. The relay optics 224 may be composed of plastic or glass. The use of plastic for the relay optics 224 may reduce the cost and weight of the relay optics 224, and accordingly of the optical engine 200. Examples of plastic that may be used for the relay optics 224 include cyclic olefin copolymer (COC), poly methyl methacrylate (PMMA), polycarbonate (PC), polystyrene (PS), or another type of optically transmissive plastic. In an example, the relay optics 224 is a single piece. In other examples, the relay optics 224 contains multiple pieces with or without air spaces. The illumination light enters the relay optics through a surface 228 from the lens array 222. In an example, the surface 228 is powered. The illumination light is reflected by a surface 230 to produce first reflected light. The surface 230 may be flat as illustrated, or it may be curved. The surface 230 may have a reflective coating, or it may reflect using total internal reflection (TIR). The first reflected light is reflected by a surface 234 by TIR to produce second reflected light, because the angle of incidence is greater than the critical angle. The second reflected light is reflected by surface 236 to produce third reflected light. As illustrated, the surface 236 is a powered, curved surface. However, in other examples, the surface 236 is flat. In an example, the surface 236 has a reflective coating. The third reflected light passes through the surface 234 as transmitted light, because the angle of incidence the third reflected light is less than the critical. The transmitted light is directed towards the prism 226.

The prism 226 is optical coupled to the relay optics 224 and to the SLM 242. In some examples, an extended pixel resolution (XPR) actuator 238 and cover glass 240 are optically coupled between the prism 226 and the SLM 242. In some examples, the XPR actuator 238 is not present. The XPR actuator 238 may be set at different angles to spatially adjust the position of the image, to produce spatially offset time multiplexed images, therefore increasing the apparent resolution of the image. The transmitted light passes through surface 244 of the prism 226. The transmitted light also passes through a surface 246 of the prism 226. The transmitted light also passes through the XPR actuator 238 and the cover glass 240 to the SLM 242. The SLM 242 modulates the transmitted light to produce modulated light. The SLM 242 applies a pattern to the transmitted light by setting pixel elements to an on state or an off state, to produce an image. The SLM 242 may be an LCoS device, an LCD device, a DMD, or another SLM. The modulated light passes through the cover glass 240 and the XPR actuator 238, and enters the prism 226 through the surface 246. The modulated light is reflected by the surface 244 of the prism 226 by TIR, because the angle of incidence of the modulated light is greater than the critical angle. The modulated light then is transmitted through a surface 248 of the prism 226, and may be directed towards projection optics (not pictured in FIGS. 2A-2D).

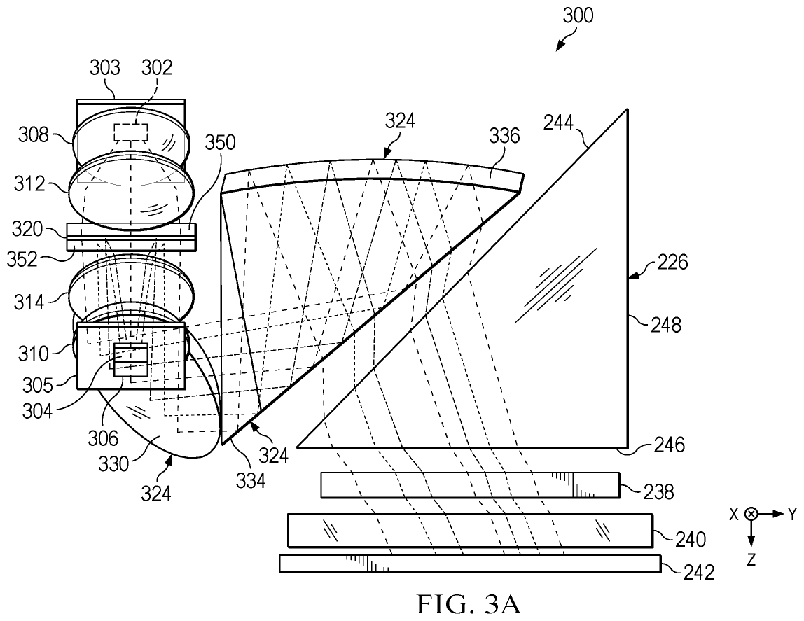

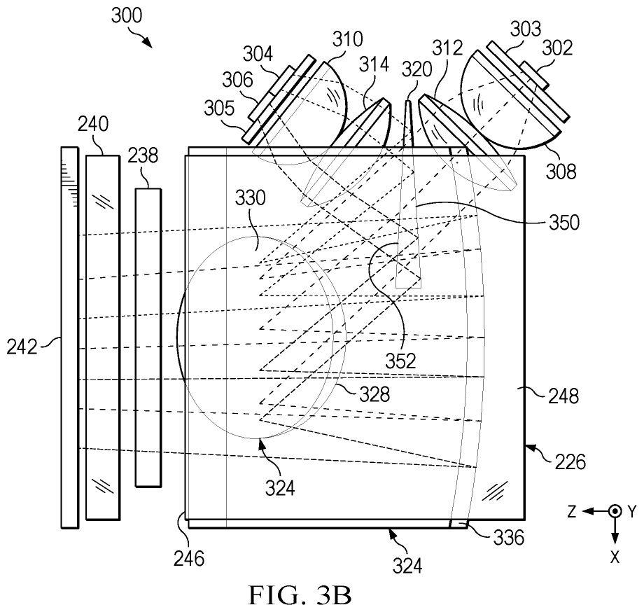

FIGS. 3A and 3B illustrate optical engine 300, which may be an example of at least a portion of the optical engine 102 illustrated in FIGS. 1A and 1B. FIG. 3A illustrates a view of the optical engine 300 along a first axis and FIG. 3B illustrates a view of the optical engine 300 along a second axis. In an example, the first axis is the YZ axis and the second axis is the XZ axis. The optical engine 300 includes an illumination module, relay optics 224, a prism 226, and an SLM 242. Compared to the optical engine 200, the illumination module of the optical engine 300 is rotated. This facilitates a tradeoff in which dimensions to minimize, to achieve a shape consistent with particular design goals.

LED 302, cover glass 303, collimating lens 308, lens 312, LED 304, LED 306, cover glass 305, collimating lens 310, lens 314, dichroic wedge 320, and the lens array (not visible in FIGS. 3A and 3B) may be an example of the illumination module 116 illustrated in FIG. 1B. LED 302, LED 304, and LED 306 are relatively small LEDs to maintain a small illumination pupil size and a low etendue, because the etendue is limited by the SLM. In an example, the LED 302 is physically and optically coupled to cover glass 303, and the LED 304 and the LED 306 are physically and optically coupled to a cover glass 305. In some examples, the cover glass 303 and the cover glass 305 are not present. In an example, the LED 302 produces first initial light having a first color, the LED 304 produces second initial light having a second color, and the LED 306 produces third initial light having a third color. In an example, the first color is green, the second color is red, and the third color is blue. In another example, the first color is green, the second color is blue, and the third color is red. In an additional example, the first color is red or blue, the second color is green, and the third color is blue or red. In an example, the first light, the second light, and the third light are time multiplexed. The LED 302 is optically coupled to collimating lens 308 and to lens 312, which direct the first initial light towards the dichroic wedge 320. The LED 304 and the LED 306, which are located adjacent to each other, are both optically coupled to collimating lens 310 and to lens 314, which direct the second light and the third light towards the dichroic wedge 320. The dichroic wedge 320 combines the first light having the first color, the second light having the second color, and the third light having a third color. The dichroic wedge 320 has surface 350 and surface 352 that reflect or transmit light based on the color of the light. Surface 350 and surface 352 of the dichroic wedge transmit the first light having the first color, directing the first light towards the lens array (not visible in FIGS. 3A and 3B)). The surface 352 reflects the third light having the third color, directing it towards the lens array (not visible in FIGS. 3A and 3B). The surface 352 transmits the second light having the second color. The second light proceeds to the surface 350, which reflects the second light having the second color. The second light is then transmitted through the surface 352, towards the lens array 322. The angle of the two surfaces of the dichroic wedge 320 are such that the second light, the third light, and the first light are centered after the dichroic wedge 320. The lens array 322, which may be a fly's eye array, homogenizes the first light, the second light, and the third light, to produce illumination light. The lens array 322 forms multiple images of the initial light on the SLM 242, where each image covers all of the SLM 242, to provide uniformity from averaging. In an example, the lens array 322 is a four by four lens array, but in other examples different sized lens arrays may be used.

Relay optics 224 is optically coupled to the illumination module and to the prism 226. There may be a small air gap between the lens array 322 and the surface 228 of the relay optics 224. In an example, the prism 226 takes up a portion of a cubic area, and the relay optics 224 takes up at least a portion of the cubic area not taken up by the prism 226, making efficient use of space. The relay optics 224 may be composed of plastic or glass. The use of plastic for the relay optics 224 may reduce the cost and weight. In an example, the relay optics 224 is a single piece to reduce complexity. In other examples, the relay optics 224 contains multiple components with or without air spaces. The illumination light enters the relay optics at a surface 228. In an example, the surface 228 is powered. The illumination light is reflected by a surface 230 to produce first reflected light. The surface 230 may be flat as illustrated, or it may be curved. The surface 230 may have a reflective coating, or it may reflect using TIR. The first reflected light is reflected by a surface 234 by TIR to produce second reflected light, because the angle of incidence is greater than the critical angle. The second reflected light is reflected by surface 236 to produce third reflected light. As illustrated, the surface 236 is a powered, curved surface. However, in other examples, the surface 236 is flat. In an example, the surface 236 has a reflective coating. The third reflected light passes through the surface 234 as transmitted light, because the angle of incidence the third reflected light is less than the critical. The transmitted light is directed towards the prism 226.

The prism 226 is optical coupled to the relay optics 224 and to the SLM 242. In some examples, an extended pixel resolution (XPR) actuator 238 and cover glass 240 are optically coupled between the prism 226 and the SLM 242. In some examples, the XPR actuator 238 is not present. The XPR actuator 238 may be set at different angles to spatially adjust the position of the image, to produce spatially offset time multiplexed images, therefore increasing the apparent resolution of the image. The transmitted light passes through surface 244 of the prism 226, because the angle of incidence is less than the critical angle. The transmitted light also passes through a surface 246 of the prism 226. The transmitted light also passes through the XPR actuator 238 and the cover glass 240 to the SLM 242. The SLM 242 modulates the transmitted light to produce modulated light. The SLM 242 applies a pattern to the transmitted light by setting pixel elements to an on state or an off state, to produce an image. The modulated light passes through the cover glass 240 and the XPR actuator 238, and enters the prism 226 through the surface 246. The modulated light is reflected by the surface 244 of the prism 226, because the angle of incidence of the modulated light is greater than the critical angle. The modulated light then is transmitted by a surface 248 of the prism 226, and may be directed towards projection optics (not pictured in FIGS. 3A and 3B).

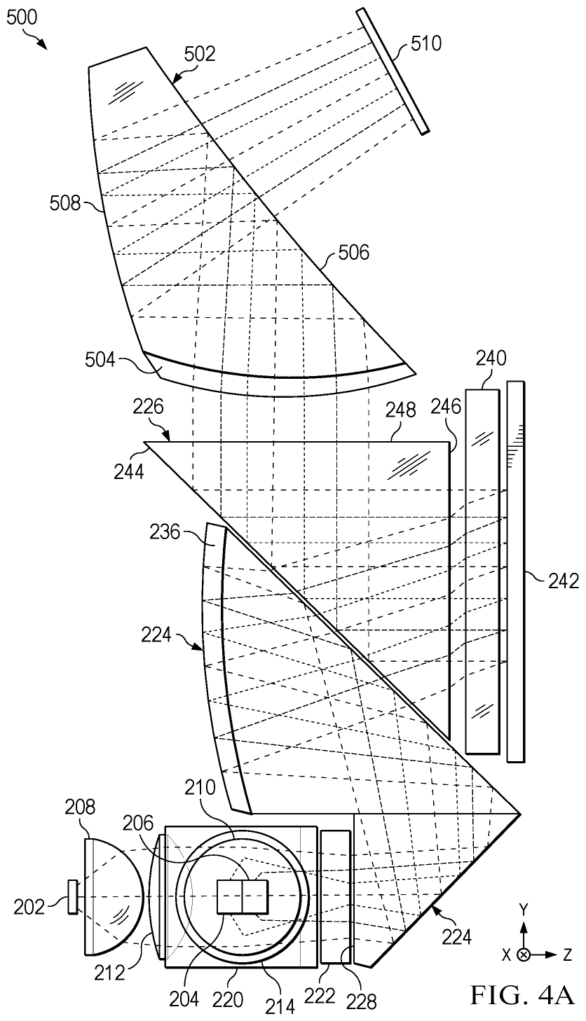

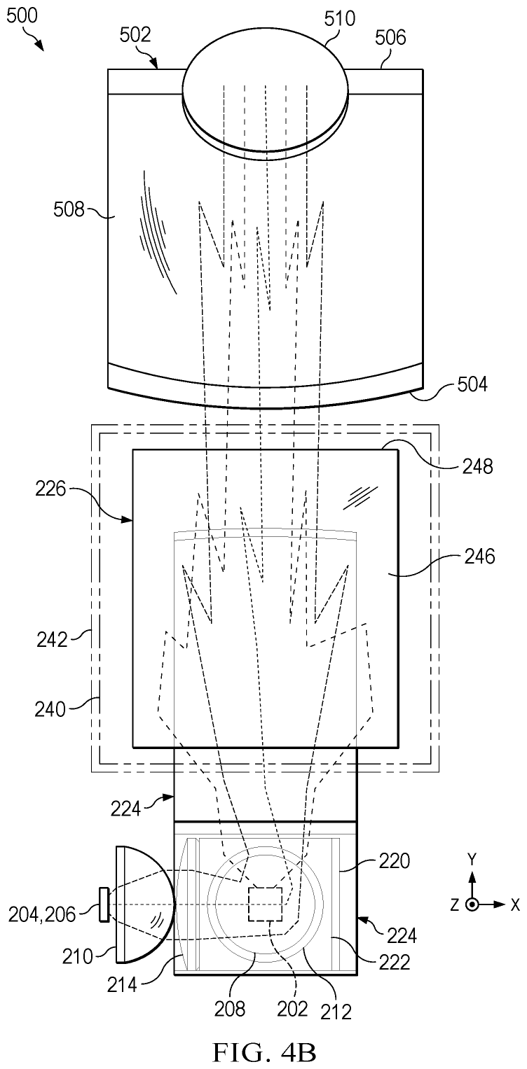

FIGS. 4A and 4B illustrate optical engine 400, which may be an example of at least a portion of the optical engine 102 illustrated in FIGS. 1A and 1B. FIG. 4A illustrates a view of the optical engine 400 along a first axis and FIG. 4B illustrates a view of the optical engine 400 along a second axis. In an example, the first axis is the YZ axis and the second axis is the XZ axis. In other examples, other axes may be used. The optical engine 400 includes an illumination module, relay optics 224, a prism 226, and an SLM 242. Compared to the optical engine 200 and the illumination module of the optical engine 300, the illumination module of the optical engine 400 is rotated. This facilitates a tradeoff in X-Y-Z dimensions, to achieve a shape consistent with particular design goals.

LED 402, cover glass 403, lens 412, LED 404, LED 406, cover glass 405, lens 414, dichroic wedge 420, and the lens array (not visible in FIGS. 4A and 4B) may be an example of the illumination module 116 illustrated in FIG. 1B. LED 402, LED 404, and LED 406 are relatively small LEDs to maintain a small illumination pupil size and a low etendue, because the etendue is limited by the SLM. In an example, the LED 402 is physically and optically coupled to cover glass 403, and the LED 404 and the LED 406 are physically and optically coupled to a cover glass 405. In some examples, the cover glass 403 and the cover glass 405 are not present. In an example, the LED 402 produces first initial light having a first color, the LED 404 produces second initial light having a second color, and the LED 406 produces third initial light having a third color. In an example, the first color is green, the second color is red, and the third color is blue. In another example, the first color is green, the second color is blue, and the third color is red. In an additional example, the first color is red or blue, the second color is green, and the third color is blue or red. In an example, the first light, the second light, and the third light are time multiplexed. The LED 402 is optically coupled to collimating lens 408 and to lens 412, which direct the first initial light towards the dichroic wedge 420. The LED 404 and the LED 406, which are located adjacent to each other, are both optically coupled to collimating lens 410 and to lens 414, which direct the second light and the third light towards the dichroic wedge 420. The dichroic wedge 420 combines the first light having the first color, the second light having the second color, and the third light having a third color. The dichroic wedge 420 has surfaces 450 and 452 that reflect or transmit light based on the color of the light. Surface 450 and surface 452 of the dichroic wedge transmit the first light having the first color, directing the first light towards the lens array. The surface 452 reflects the third light having the third color, directing it towards the lens array. The surface 452 transmits the second light having the second color. The second light proceeds to the surface 450, which reflects the second light having the second color. The second light is then transmitted through the surface 452, towards the lens array. The angle of the two surfaces of the dichroic wedge 420 are such that the second light, the third light, and the first light are centered after the dichroic wedge 420. The lens array homogenizes the first light, the second light, and the third light, to produce illumination light. The lens array forms multiple images of the initial light on the SLM 242, where each image covers all of the SLM 242, to provide uniformity from averaging. In an example, the lens array is a four by four lens array, but in other examples different sized lens arrays may be used.

Relay optics 224 is optically coupled to the illumination module, in particular to the lens array, and to the prism 226. There may be a small air gap between the lens array and the surface 228 of the relay optics 224. In an example, the prism 226 takes up a portion of a cubic area, and the relay optics 224 takes up at least a portion of the cubic area not taken up by the prism 226, making efficient use of space. The relay optics 224 may be composed of plastic or glass. The use of plastic for the relay optics 224 may reduce the cost and weight of the relay optics 224 and the optical engine 400. In an example, the relay optics 224 is a single piece. In other examples, the relay optics 224 contains multiple components with or without air spaces. The illumination light enters the relay optics 224 at a surface 228. In an example, the surface 228 is powered. The illumination light is reflected by a surface 230 to produce first reflected light. The surface 230 may be flat as illustrated, or it may be curved. The surface 230 may have a reflective coating, or it may reflect using TIR. The first reflected light is reflected by a surface 234 by TIR to produce second reflected light, because the angle of incidence is greater than the critical angle. The second reflected light is reflected by surface 236 to produce third reflected light. As illustrated, the surface 236 is a powered, curved surface. However, in other examples, the surface 236 is flat. In an example, the surface 236 has a reflective coating. The third reflected light passes through the surface 234 as transmitted light, because the angle of incidence the third reflected light is less than the critical. The transmitted light is directed towards the prism 226.

The prism 226 is optical coupled to the relay optics 224 and to the SLM 242. In some examples, an extended pixel resolution (XPR) actuator 238 and cover glass 240 are optically coupled between the prism 226 and the SLM 242. In some examples, the XPR actuator 238 is not present. The XPR actuator 238 may be set at different angles to spatially adjust the position of the image, to produce spatially offset time multiplexed images, therefore increasing the viewed resolution of the image. The transmitted light passes through surface 244 of the prism 226, because the angle of incidence is less than the critical angle. The transmitted light also passes through a surface 246 of the prism 226. The transmitted light also passes through the XPR actuator 238 and the cover glass 240 to the SLM 242. The SLM 242 modulates the transmitted light to produce modulated light. The SLM 242 applies a pattern to the transmitted light by setting pixel elements to an on state or an off state, to produce an image. The modulated light passes through the cover glass 240 and the XPR actuator 238, and enters the prism 226 through the surface 246. The modulated light is reflected by the surface 244 of the prism 226, because the angle of incidence of the modulated light is greater than the critical angle. The modulated light then is transmitted by a surface 248 of the prism 226, and may be directed towards projection optics (not pictured in FIGS. 4A and 4B).

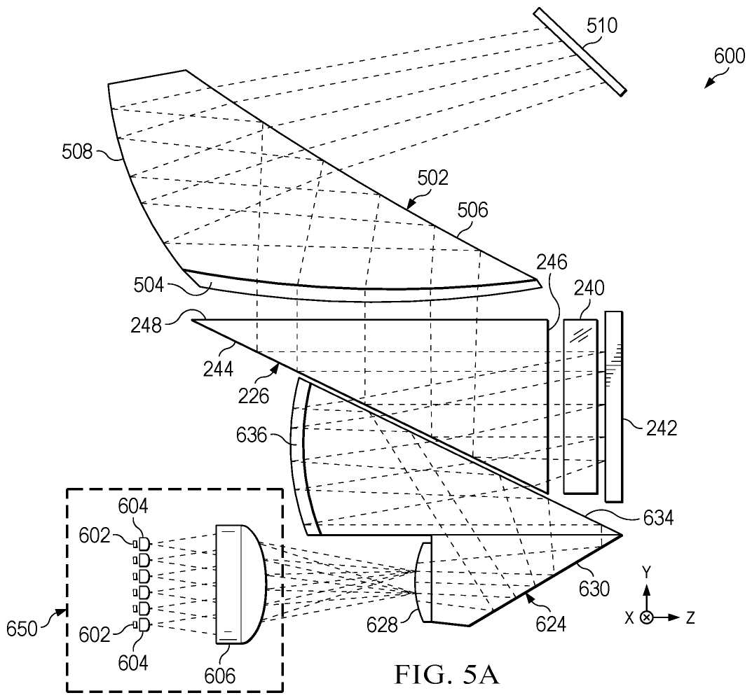

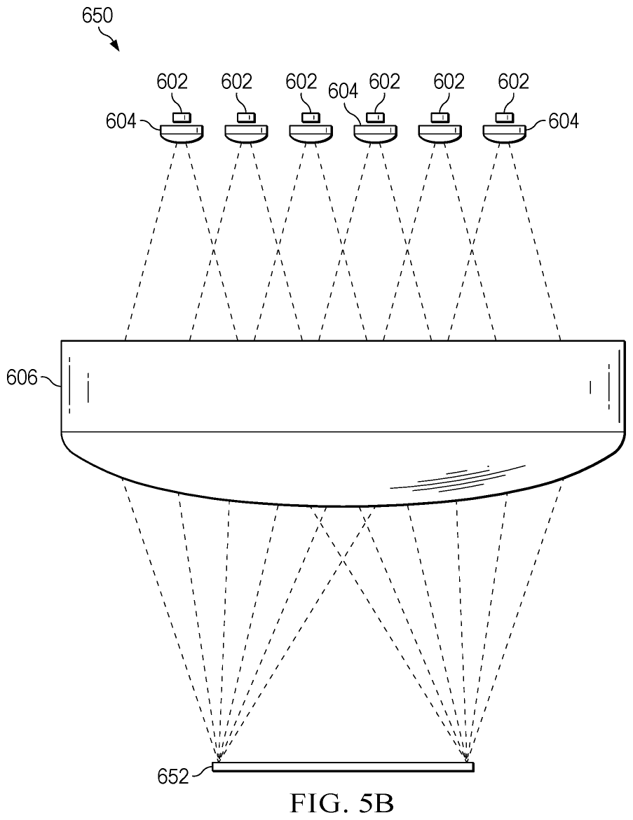

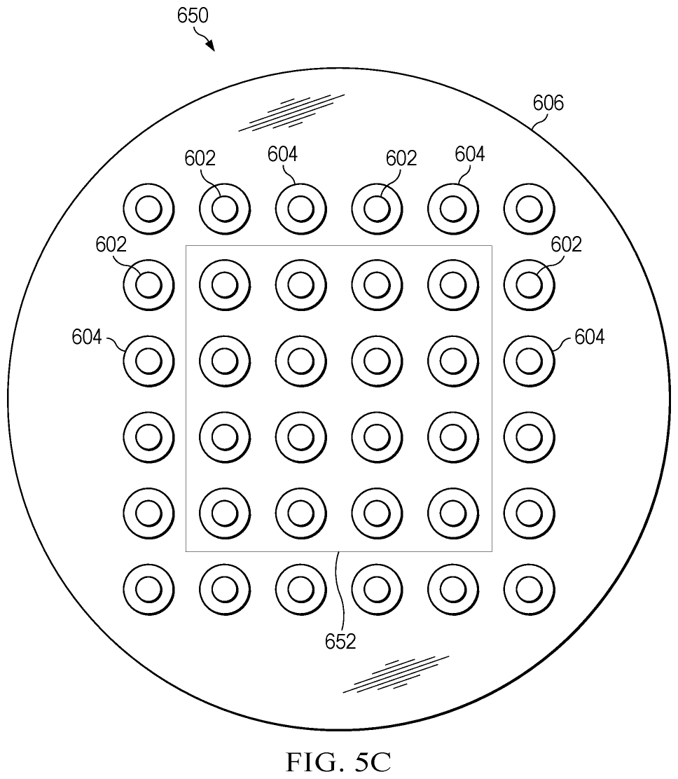

FIGS. 5A and 5B illustrate optical engine 500, which may be an example of the optical engine 102, illustrated in FIGS. 1A and 1B. FIG. 5A illustrates a view of the optical engine 200 along a first axis and FIG. 5B illustrates a view of the optical engine 200 along a second axis. The optical engine 500 includes an illumination module, relay optics 224, a prism 226, an SLM 242, a freeform eyepiece 502, and a projection surface 510. The use of the freeform eyepiece 502 along with the relay optics 224 makes the optical engine 500 compact and relatively low cost. Also, using plastic for the freeform eyepiece 502 and the relay optics 224 may reduce the cost and weight of the optical engine 500.

LED 202, collimating lens 208, lens 212, LED 204, LED 206, collimating lens 210, lens 214, dichroic wedge 220, and lens array 222 may be an example of the illumination module 116 illustrated in FIG. 1B. LED 202, LED 204, and LED 206 are relatively small LEDs to maintain a small illumination pupil size and a low etendue, because the etendue is limited by the SLM. In an example, the LED 202 is optically coupled to the collimating lens 208, and the LED 204 and the LED 206 are optically coupled to the collimating lens 210. In an example, the LED 202 produces first initial light having a first color, the LED 204 produces second initial light having a second color, and the LED 206 produces third initial light having a third color. In an example, the first color is green, the second color is red, and the third color is blue. In another example, the first color is green, the second color is blue, and the third color is red. In an additional example, the first color is red or blue, the second color is green, and the third color is blue or red. In an example, the first light, the second light, and the third light are time multiplexed. The LED 202 is optically coupled to collimating lens 208 and to lens 212, which direct the first initial light towards the dichroic wedge 220. The LED 204 and the LED 206, which are located adjacent to each other, are both optically coupled to collimating lens 210 and to lens 214, which direct the second light and the third light towards the dichroic wedge 220. The dichroic wedge 220 combines the first light having the first color, the second light having the second color, and the third light having a third color. The angle of the two surfaces of the dichroic wedge 220 are such that the second light, the third light, and the first light are centered after the dichroic wedge 220. The lens array 222 homogenizes the first light, the second light, and the third light, to produce illumination light. The lens array 222 forms multiple images of the initial light on the SLM 242, where each image covers all of the SLM 242, to provide uniformity from averaging. In an example, the lens array 222 is a four by four lens array, but in other examples different sized lens arrays may be used.

Relay optics 224 is optically coupled to the illumination module, in particular to the lens array 222, and to the prism 226. There may be a small air gap between the lens array 222 and the surface 228 of the relay optics 224. In an example, the prism 226 takes up a portion of a cubic area, and the relay optics 224 takes up at least a portion of the cubic area not taken up by the prism 226, making efficient use of space. The relay optics 224 may be composed of plastic or glass. The use of plastic for the relay optics 224 may reduce the cost and weight of the relay optics 224 and the optical engine 500. In an example, the relay optics 224 is a single piece. In other examples, the relay optics 224 contains multiple components with or without air spaces. The illumination light enters the relay optics at a surface 228. In an example, the surface 228 is powered. The illumination light is reflected by a surface 230 to produce first reflected light. The surface 230 may be flat as illustrated, or it may be curved. The surface 230 may have a reflective coating, or it may reflect using TIR. The first reflected light is reflected by a surface 234 by TIR to produce second reflected light, because the angle of incidence is greater than the critical angle. The second reflected light is reflected by surface 236 to produce third reflected light. As illustrated, the surface 236 is a powered, curved surface. However, in other examples, the surface 236 is flat. In an example, the surface 236 has a reflective coating. The third reflected light passes through the surface 234 as transmitted light, because the angle of incidence the third reflected light is less than the critical. The transmitted light is directed towards the prism 226.

The prism 226 is optical coupled to the relay optics 224, to the SLM 242, and to the freeform eyepiece 502. In some examples, cover glass 240 is optically coupled between the prism 226 and the SLM 242. The transmitted light passes through surface 244 of the prism 226, because the angle of incidence is less than the critical angle. The transmitted light also passes through a surface 246 of the prism 226. The transmitted light also passes through the cover glass 240 to the SLM 242. The SLM 242 modulates the transmitted light to produce modulated light. The SLM 242 applies a pattern to the transmitted light by setting pixel elements to an on state or an off state, to produce an image. The modulated light passes through the cover glass 240 and enters the prism 226 through the surface 246. The modulated light is reflected by the surface 244 of the prism 226, because the angle of incidence of the modulated light is greater than the critical angle. The modulated light then is transmitted by a surface 248 of the prism 226, towards the freeform eyepiece 502.

The freeform eyepiece 502 is optically coupled to the prism 226. The freeform eyepiece 502 may be an example of the projection optics 106 illustrated in FIG. 1B. The freeform eyepiece 502 is composed of plastic or glass. The use of plastic for the freeform eyepiece 502 may reduce the cost and weight. The freeform eyepiece 502 has a solid, one-piece, freeform shape that is rotationally asymmetric. The freeform eyepiece 502 has a surface 504, a surface 508, and a surface 506. The modulated light enters the freeform eyepiece 502 through the surface 504. The surface 504 has an extended polynomial shape. The modulated light is then reflected off of the surface 506 to produce fourth reflected light, due to TIR. The surface 506 has an extended polynomial shape. The fourth reflected light reflects off the surface 508 to produce fifth reflected light. The surface 508 has a biconic zernike shape. The surface 508 may have a reflective coating. The fifth reflected light is then transmitted through the surface 506 as second transmitted light, because the angle of incidence is less than the critical angle. The second transmitted light forms an image at the projection surface 510.

FIG. 6A illustrates an optical engine 600, which may be an example of the optical engine 102 illustrated in FIGS. 1A and 1B. In other examples, the optical engine 600 is an optical engine for a different optical system. The optical engine 600 includes an illumination source 650, relay optics 224, prism 226, cover glass 240, SLM 242, freeform eyepiece 502, and projection surface 510. FIG. 6B illustrates a cross sectional view of the illumination source 650 and FIG. 6C illustrates a top down view of the illumination source 650. In an example, the illumination source 650 is used in a different type of optical engine. In an example, the illumination source 650 has pupil matching. The illumination source 650 contains an array of light sources 602. In an example, the array of light sources 602 is a two dimensional array. In other examples, the array of light sources 602 is a one dimensional array of light sources. Using a two dimensional array of light sources 602 may enable a two dimensional array of zones on the SLM 242, which may be well suited for producing a high dynamic range (HDR) image. The use of a one dimensional array of light sources 602 may be useful when forming an image with a high aspect ratio, for example as part of a smart headlight. In the illustrated example, the array of light sources 602 is a six by six array, but it may be a different sized array, for example two by two, four by four, five by five, eight by eight, two by four, two by six, four by six, two by six, one by four, one by six, or another array size. The array of light sources 602 may be an array of LEDs, an array of miniLEDs, an array of microLEDs, an array of laser diodes, an array of fiber light sources, or an array of another light source. It is desirable for the area of each individual light source be small to maintain a low etendue. In an example, the individual light sources of the array of light sources 602 has multiple colors, with or without color combination. In another example, the individual light sources of the array of light sources 602 are a single color. In an example, the light sources of the array of light sources 602 have alternating colors. In another example, the light sources of the array of light sources 602 have the same color.

In an example, the array of light sources 602 is optically coupled to an array of collimating lenses 604, where each light source is optically coupled to a corresponding collimating lens. In some examples, the array of collimating lenses 604 is not present. The array of light sources 602 is optically coupled to the lens 606. The lens 606 may be a single element, multiple lenses, and/or Fresnel lenses. The individual light sources of the array of light sources 602 illuminate different zones of the SLM 242. Accordingly, some light sources of the array of light sources 602 may be turned off to reduce power expenditure. Additionally, high dynamic range (HDR) functionality may be achieved by turning off or dimming some of the light sources of the array of light sources 602. In an example, the zones corresponding to individual light sources of the array of light sources 602 overlap on the SLM 242.

The relay optics 624 is optically coupled to the illumination source 650 and to the prism 226. In an example, the relay optics 624 is a single-piece relay optic. In other examples, the relay optics 624 contains multiple pieces, with or without air gaps. The relay optics 624 may be composed of plastic or glass. Using plastic for the relay optics 624 may reduce the weight and cost of the optical engine 600. The lens 606 focuses the illumination light from the array of light sources 602 towards the surface 628 of relay optics 624. The illumination light passes through the surface 628 into the relay optics 624. In an example, the surface 628 is a powered surface. The illumination light is reflected off of a surface 630 to produce first reflected light. The surface 630 may be flat, as illustrated, or it may be curved. The first reflected light is reflected by a surface 634 of the relay optics 624 by TIR to produce second reflected light. The second reflected light is reflected by a surface 636 of the relay optics 624 to produce third reflected light. The third reflected light is transmitted towards the prism 226 by the surface 634 of the relay optics 624. In an example, the relay optics 624 defocuses the light so that the zones on the SLM 242 have a particular zone overlap.

The prism 226 is optical coupled to the relay optics 624, to the SLM 242, and to the freeform eyepiece 502. In other examples (not pictured) a different projection optics, for example three projection lenses, is used instead of the freeform eyepiece 502. In some examples, cover glass 240 is optically coupled between the prism 226 and the SLM 242. The transmitted light passes through surface 244 of the prism 226, because the angle of incidence is less than the critical angle. The transmitted light also passes through the cover glass 240 to the SLM 242. The SLM 242 modulates the transmitted light to produce modulated light. The SLM 242 has multiple zones, where each zone is illuminated by a different light source of the array of light sources 602. In an example, the zones of the SLM 242 overlap. The SLM 242 applies a pattern to the transmitted light by setting pixel elements to an on state or an off state, to produce an image. In an example, dimming or turning off some of the light sources causes variation in the illumination of respective zones of the SLM 242, enabling the optical engine 600 to produce an HDR image. The modulated light passes through the cover glass 240 and enters the prism 226 through the surface 246. The modulated light is reflected by the surface 244 of the prism 226, because the angle of incidence of the modulated light is greater than the critical angle. The modulated light then is transmitted by a surface 248 of the prism 226, towards the freeform eyepiece 502.

The freeform eyepiece 502 is optically coupled to the prism 226. The freeform eyepiece 502 may be an example of the projection optics 106 illustrated in FIG. 1B. The freeform eyepiece 502 is composed of plastic or glass. The use of plastic for the freeform eyepiece 502 may reduce the cost and weight. The freeform eyepiece 502 has a solid, one-piece, freeform shape that is rotationally asymmetric. The freeform eyepiece 502 has a surface 504, a surface 508, and a surface 506. The modulated light enters the freeform eyepiece 502 through the surface 504. The surface 504 has an extended polynomial shape. The modulated light is then reflected off of the surface 506 to produce fourth reflected light, due to TIR, because the angle of incidence is greater than the critical angle. The surface 506 has an extended polynomial shape. The fourth reflected light reflects off the surface 508 to produce fifth reflected light. The surface 508 has a biconic zernike shape. The fifth reflected light is then transmitted through the surface 506 as second transmitted light, because the angle of incidence is less than the critical angle. The second transmitted light forms an image at the projection surface 510. In some examples, the image is an HDR image.

Moreover, the scope of the present application is not intended to be limited to the particular illustrative example arrangement of the process, machine, manufacture, and composition of matter means, methods and steps described in this specification. As one of ordinary skill in the art will readily appreciate from the disclosure, processes, machines, manufacture, compositions of matter, means, methods or steps, presently existing or later to be developed, that perform substantially the same function or achieve substantially the same result as the corresponding example arrangements described herein may be utilized according to the illustrative arrangements presented and alternative arrangements described, suggested or disclosed. Accordingly, the appended claims are intended to include within their scope such processes, machines, manufacture, compositions of matter, means, methods, or steps.

What is claimed is:

1. A system comprising:
an illumination module configured to produce illumination light;
a prism;
relay optics optically coupled between the illumination module and the prism, the relay optics having a first surface, a second surface, and a third surface, the first surface configured to reflect the illumination light to produce first reflected light, the second surface configured to reflect the first reflected light to produce second reflected light, the third surface configured to reflect the second reflected light to produce third reflected light, and the second surface configured to transmit the third reflected light to produce transmitted light towards the prism; and
a spatial light modulator (SLM) optically coupled to the prism, wherein the prism is configured to direct the transmitted light towards the SLM, and the SLM is configured to produce modulated light based on the transmitted light.

2. The system of claim 1, wherein the relay optics is a single piece.

3. The system of claim 1, wherein the relay optics comprises plastic.

4. The system of claim 1, wherein the illumination module comprises:
an array of light emitting diodes (LEDs);
an array of collimating lenses optically coupled to the array of LEDs; and
at least one lens optically coupled to the array of collimating lenses.

5. The system of claim 1, further comprising projection optics optically coupled to the prism, wherein the prism is configured to direct the modulated light towards the projection optics, and wherein the projection optics is configured to project the modulated light to produce projection light.

6. The system of claim 5, wherein the projection optics comprises a freeform eyepiece.

7. The system of claim 5, further comprising a waveguide optically coupled to the projection optics.

8. The system of claim 1, wherein the illumination module comprises:
a first LED;
a first collimating lens optically coupled to the first LED;
a first lens optically coupled to the first collimating lens;
a second LED;
a third LED;
a second collimating lens optically coupled to the second LED and to the third LED;
a second lens optically coupled to the second collimating lens;
a dichroic wedge optically coupled to the first lens and to the second lens; and
a lens array optically coupled to the dichroic wedge.

9. A system comprising:
an illumination module;
a prism;
a single-piece relay optics optically coupled between the illumination module and the prism; and
a spatial light modulator (SLM) optically coupled to the prism.

10. The system of claim 9, wherein the single-piece relay optics comprises glass.

11. The system of claim 9, wherein the illumination module comprises:
a first LED;
a first collimating lens optically coupled to the first LED;
a first lens optically coupled to the first collimating lens;
a second LED;
a third LED;
a second collimating lens optically coupled to the second LED and to the third LED;
a second lens optically coupled to the second collimating lens;
a dichroic wedge optically coupled to the first lens and to the second lens; and
a lens array optically coupled to the dichroic wedge.

12. The system of claim 9, further comprising projection optics optically coupled to the prism.

13. The system of claim 12, wherein the projection optics is a freeform eyepiece.

14. The system of claim 12, further comprising a waveguide optically coupled to the projection optics.

15. A system comprising:
an array of light emitting diodes (LEDs) comprising a first LED configured to produce first light and a second LED configured to produce second light;
relay optics;
at least one lens optically coupled between the array of LEDs and the relay optics, the at least one lens configured to direct the first light and the second light towards the relay optics;
a spatial light modulator (SLM); and
a prism optically coupled between the relay optics and the spatial light modulator, wherein the relay optics is configured to direct the first light and the second light towards the prism, and wherein the prism is configured to direct the first light towards a first zone of the SLM and to direct the second light towards a second zone of the SLM.

16. The system of claim 15, further comprising an array of collimating lenses optically coupled between the array of LEDs and the at least one lens.

17. The system of claim 15, wherein the array of LEDs is a two dimensional array of LEDs.

18. The system of claim 15, wherein the array of LEDs is an array of miniLEDs or an array of microLEDs.

19. The system of claim 15, wherein the first LED is configured to turn off while the second LED is turned on.

20. The system of claim 15, wherein the first zone overlaps the second zone.
